(19) United States
(12) Patent Application Publication
(10) Pub. No.: US 2017/0039462 A1
(43) Pub. Date: Feb. 9, 2017

(54) Contact Smart Card and Method of Forming Such

(71) Applicant: Johnson Electric S.A., Murten (CH)

(72) Inventor: Arthur Demaso, Hong Kong (CN)

(21) Appl. No.: 15/209,171

(22) Filed: Jul. 13, 2016

Related U.S. Application Data
(60) Provisional application No. 62/200,451, filed on Aug. 3, 2015.

(51) Int. Cl. G06K 19/02; G06K 19/077; G06K 19/04

(52) U.S. Cl. CPC G06K 19/022; G06K 19/044; G06K 19/07743; G06K 19/07722

(57) ABSTRACT

Contact smart card has a smart card contact pad and an IC chip. The smart card contact pad has a circuit substrate with a plurality of via holes there through, a card-reader contact element on a first side of the circuit substrate, and a plurality of chip connection elements on a second side of the circuit substrate. Each chip connection element is associated with a via hole through the circuit substrate. The card-reader contact element has an electrically conductive surface. The plurality of chip connection elements define a chip engagement region on the second side of the circuit substrate. The IC chip is mounted on the chip engagement region and electrically connected to the card-reader contact element through the via holes.

### CROSS REFERENCE TO RELATED APPLICATIONS

This non-provisional patent application claims priority under 35 U.S.C. §119(e) from Provisional Patent Application No. 62/200,451 filed in USA on Aug. 3, 2015, the entire contents of which are hereby incorporated by reference.

### FIELD OF THE INVENTION

This invention relates to a contact smart card and to a method of forming such a card, the method requiring the use of less precious metal than existing designs of contact smart card.

### BACKGROUND OF THE INVENTION

There are two primary methods of forming a contact smart card and/or module such that the integrated circuit (IC) chip is positioned on the opposite side of its substrate to the contact surface: using wirebonding; and using the flipchip method. The problem of forming such a smart card lies in the need to make an electrical connection between the two opposing sides of the substrate.

In the wirebonding method, the base substrate, typically an FR-4 (Flame Retardant 4) material, has via holes punched through it. A copper layer is then laminated onto a first side of the substrate, which is then etched and surface finished to form a circuit. The IC chip is affixed to the second side of the substrate, and gold wires bonded to make a connection between the terminals of the IC chip and the copper circuit on the first side, through the via holes.

There are issues with the wirebonding method, however; the gold wires are fragile, and therefore the entire wirebonded IC chip needs to be encapsulated in a resinous substance in order to prevent damage and/or oxidation of the wires. Furthermore, a significant amount of gold is required in order to form the wires and interfaces with the copper layer, which can be expensive.

The alternative to wirebonding is to use the flipchip method. A base substrate of polyethylene terephthalate (PET) having a copper laminate on both sides is used, and via holes are drilled using a laser. The whole substrate is then copper plated so as to provide conductive copper passing through the via holes. The surface copper is etched and finished, forming circuitry on both sides of the PET. An IC chip having stud bumps is then positioned so as to contact the circuitry on one side, and the IC chip is adhered in place.

By removing the wires from the module, the flipchip assembly is by default more robust than an equivalent wirebonded module, and the amount of gold used can be reduced. However, a large amount of copper is used in construction of the assembly, and the laser drilling of the via holes can cause damage to the etched circuit, resulting in a greater incidence of faulty circuitry.

Furthermore, the attachment of the IC chip using the stud bumps can result in an outdentation on the ISO regulated contact side of the substrate, since PET is less resilient that FR-4 equivalents. Finally, due to the location of the contact pad in the flipchip assembly being predetermined, a different design is required in order to accommodate each type of chip, whereas a wirebonded smart card module allows for some manual customization.

### SUMMARY OF THE INVENTION

Hence there is a desire for an improved contact smart card.

According to a first aspect of the invention there is provided a contact smart card comprising: a smart card contact pad; and an IC chip; wherein the smart card contact pad comprises: a circuit substrate including a plurality of via holes there through; a card-reader contact element on a first side of the circuit substrate; and a plurality of chip connection elements on a second side of the circuit substrate which is opposite the first side, each chip connection element being associated with a via hole through the circuit substrate; the card-reader contact element having an electrically conductive surface; the plurality of chip connection elements defining a chip engagement region on the second side of the circuit substrate; and the IC chip being mounted on the chip engagement region and electrically connected to the card-reader contact element through the via holes.

By providing a contact smart card which utilizes chip connection elements which are directly affixed to a surface of the circuit substrate, the IC chip can be attached such that its chip terminals are in close contact with the chip connection elements. This results in a robust and slimline device.

Preferably, the smart card may further comprise an adhesive to adhere the IC chip to the chip engagement region.

Attaching the IC chip to the smart card contact pad using an adhesive limits or prevents accidental short-circuiting of the smart card, which is more likely when an electrically conductive attachment means is utilized.

In a preferred embodiment, the circuit substrate may be formed from an FR-4 grade epoxy glass laminate material.

FR-4 grade epoxy glass laminate material is a mature substrate; circuits can be affixed to the substrate with a much lower rate of malfunction when compared with a flexible PET substrate. This advantageously results in more reliable contact smart cards.

Optionally, each of the plurality of chip connection elements may fill its respective via hole with which it is associated.

Filling the via hole connecting the first and second sides of the circuit substrate ensures that the electrical connection there between is robust, particularly when compared with fragile wirebonding techniques.

Preferably, the first side of the circuit substrate may include an electrically conductive laminate layer, the second side of the circuit substrate not being laminated with an electrically conductive layer. The electrically conductive laminate layer may form the card-reader contact element, and may be formed from copper. Ideally, the contact smart card may be a single-sided contact smart card module.

A single-sided circuit substrate advantageously reduces the amount of precious metal which is required to construct the smart card, resulting in a more cost-effective device.

According to a second aspect of the invention, there is provided a method of forming a contact smart card without wirebonding, the method comprising the steps of: a] providing a circuit substrate having a first side including an electrically conductive laminate layer thereon and a second side which is not laminated with an electrically conductive layer; b] creating a via hole through the circuit substrate between the first and second sides; c] applying an electrically conductive chip connection element directly to the second side of the circuit substrate at or adjacent the via hole, such that the electrically conductive chip connection element is in electrical contact with the electrically conductive laminate layer through the via hole; and d] affixing an IC chip to the second side of the circuit substrate, such that the IC chip is in electrical communication with the electrically conductive laminate layer via the electrically conductive chip connection element.

Preferably, a plurality of said via holes and electrically conductive chip connection elements may be provided, the plurality of electrically conductive chip connection elements forming a chip engagement region capable of engaging with the IC chip. Additionally or alternatively, during step b], the via hole may be formed as a mechanically punched hole in the circuit substrate. The IC chip may be affixed to the second side of the circuit substrate using an adhesive, and/or the circuit substrate may be formed from an FR-4 grade epoxy glass laminate material.

By providing an alternative method of forming a contact smart card to wirebonding or the flipchip technique, it is possible to reduce the amount of precious material, such as gold, silver, and/or platinum, for example, as well as reduce the amount of noble materials, such as ruthenium, rhodium, palladium, silver, osmium, iridium, platinum, and gold used in the construction of the smart card, whilst also providing a robust and slimline device with improved electrical connection.

According to a third aspect of the invention, there is provided a contact smart card comprising: a smart card contact pad; and an IC chip; wherein the smart card contact pad comprises: a circuit substrate including a plurality of via holes there through; a card-reader contact element on a first side of the circuit substrate; and a plurality of chip connection elements formed from an electrically conductive material and positioned on a second side of the circuit substrate which is opposite the first side, each chip connection element being associated with and extending into a via hole through the circuit substrate; the card-reader contact element being formed from an electrically conductive material having an electrically conductive surface, wherein the card-reader contact element is formed from a different electrically conductive material to the plurality of chip connection elements; the plurality of chip connection elements defining a chip engagement region on the second side of the circuit substrate; and the IC chip being adhesively mounted on the chip engagement region and electrically connected to the card-reader contact element through the via holes.

Preferably, the circuit substrate may be formed from an FR-4 grade epoxy glass laminate material. Each of the plurality of chip connection elements may fill its respective via hole with which it is associated.

Optionally, the contact smart card may be a single-sided contact smart card module, in which the electrically conductive laminate layer may form the card-reader contact element, which may be formed from copper.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a cross-sectional representation through a first prior art embodiment of a contact smart card, formed in accordance with a known wirebonding method;

FIG. 2 shows a cross-sectional representation through a second prior art embodiment of a contact smart card, formed in accordance with a known flipchip method;

FIG. 3 shows a cross-sectional representation through one embodiment of a contact smart card in accordance with the first aspect of the invention;

FIG. 4 shows a top plan pictorial representation of the contact smart card of FIG. 3; and

FIG. 5 shows a diagrammatic representation of a method of forming a contact smart card without wirebonding in accordance with the second aspect of the invention.

### DETAILED DESCRIPTION OF THE PREFERRED EMBODIMENTS

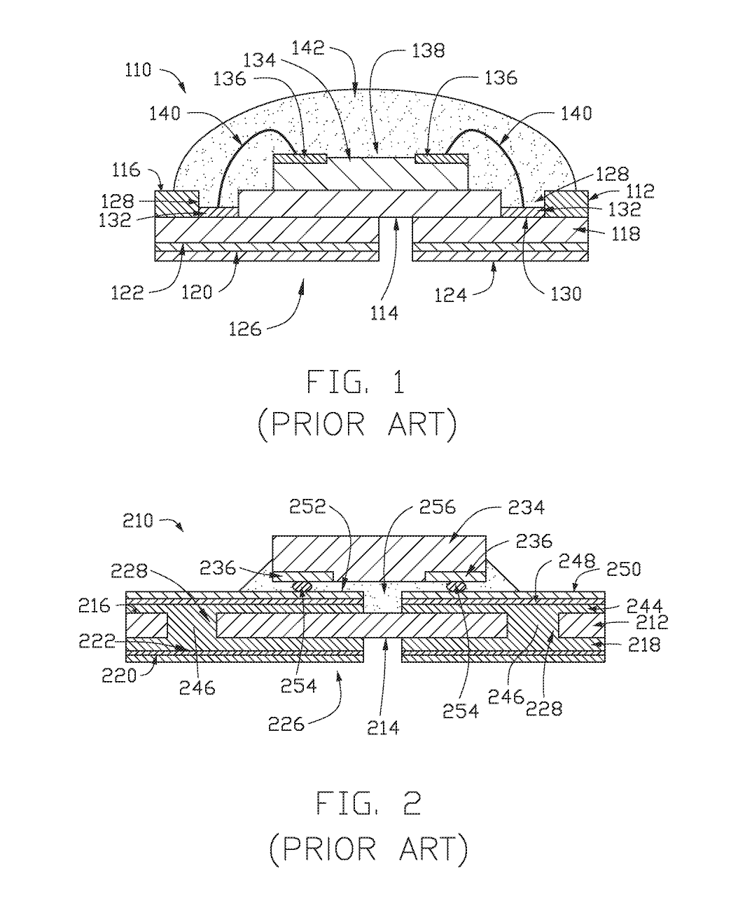

FIG. 1 illustrates a first prior art embodiment of a contact smart card or smart card module, indicated globally at 110, and formed in accordance with a known wirebonding technique.

The contact smart card 110 comprises a circuit substrate 112, which here is a printed circuit board formed from a glass epoxy laminate having an FR-4 grade designation. The circuit substrate 112 has opposed first and second planar sides 114, 116.

On the first side 114 of the circuit substrate 112 is provided an electrically conductive layer 118, formed as a copper laminate, which is surface finished with inner and outer finish plating layers 120, 122, which are here respectively nickel and gold plated layers. These inner and outer layers 120, 122 protect the underlying copper layer 118, and provide for a highly-electrically conductive surface 124 of the first side 114 of the circuit substrate 112. The finished electrically conductive layer 118 thereby forms a card-reader contact element 126 of the smart card 110.

On the second side 116 of the circuit substrate 112, there is no such electrically conductive layer.

Through the circuit substrate 112 are provided a plurality of via holes 128 extending between the first and second sides 114, 116 of the circuit substrate 112, and which expose a rear surface 130 of the electrically conductive layer 118 to the second side 116 of the substrate 112. Within each via hole 128, the rear surface 130 of the electrically conductive layer 118 is surface plated with a via plating layer 132, in this instance, formed from gold plating.

At or adjacent to the via holes 128 on the second side 116 of the circuit substrate 112 is affixed an IC chip 134 having a plurality of chip terminals 136 positioned on an upper surface 138 of the IC chip 134. Between one chip terminal 136 and one via plating layer 132 within a via hole 128 is positioned and secured an electrically conductive wire 140, here formed from gold wire. An electrically conductive wire 140 may be provided to connect each chip terminal 136 with a respective via plating layer 132.

The electrically conductive wire 140 provides an electrical connection between the chip terminal 136 through the via hole 128 to a circuit formed in the electrically conductive layer 118 on the first side 114 of the circuit substrate 112.

To protect the electrically conductive wires 140 from damage, and also to secure the IC chip 134 and wires 140 in situ, a resinous encapsulant 142 is provided so as to envelop both the IC chip 134 and wires 140, and fill in the void space in the via holes 128. This encapsulant 142 is electrically insulating so as to prevent any short-circuiting on the second side 116 of the circuit substrate 112.

This prior art embodiment 110 illustrates the issues associated with wirebonding; the IC chip 134 and wires 140 must be encapsulated to prevent the fragile wires 140 from becoming damaged, but the encapsulant 142 significantly adds to the thickness of the contact smart card 110. Furthermore, because there is no electrically conductive layer on the second surface 116 of the circuit substrate 112, the IC chip 134 must be positioned with its chip terminals 136 facing away from the circuit substrate 112, necessitating the projection of the wirebonding wires 140.

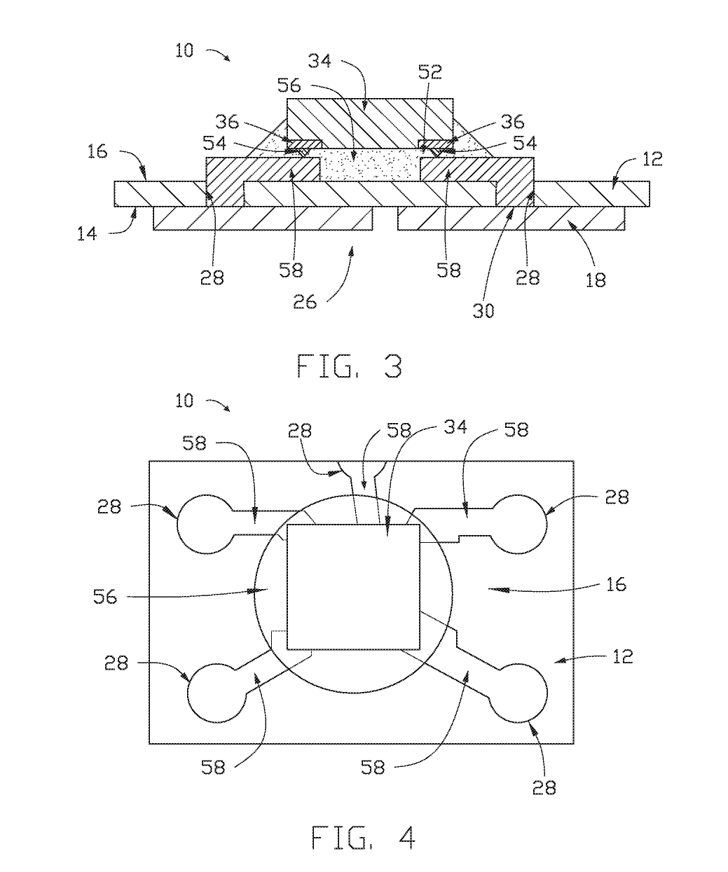

FIG. 2 shows a second prior art embodiment of a contact smart card or smart card module, indicated globally at 210, and formed in accordance with the flipchip method. Similar or identical components to those referred to in the first prior art embodiment utilize similar or identical references, and further detailed description will be omitted for brevity.

A circuit substrate 212 having first and second sides 214, 216 and a plurality of via holes 228 there through is provided. However, in the flipchip method of forming a contact smart card 210, the circuit substrate 212 is formed by sputtering of PET, which is significantly less robust and rigid when compared with a glass epoxy laminate as utilized in the wirebonded embodiment described above.

The circuit substrate 212 is formed having first and second electrically conductive layers 218, 244 respectively on the first and second sides 214, 216 of the circuit substrate 212, preferably by electro-deposition following sputtering of the electrically conductive layers 218, 244 to the desired thickness, typically 1 to 2 μm, after which the via holes 228 are formed using laser ablation. The circuit substrate 212 is copper plated to ensure that there is an electrically conductive material 246 formed within the via holes 228.

The first and second electrically conductive layers 218, 244 can then be etched to form the desired circuit form on the circuit substrate 212, and can be respectively plated with first and second, inner and outer surface plating layers 222, 220, 248, 250, again commonly formed from nickel and gold plate respectively. Again, the circuit on the first side 214 forms a card-reader contact element 226.

In this arrangement, the circuit formed on the second side 216 of the circuit substrate 212 can be formed independently of the position of the via holes 228, with a chip engagement region 252 being defined on the second side 216 of the circuit substrate 212 as being the area in which the IC chip 234 should be affixed.

The IC chip 234 is provided with chip terminals 236 which are in direct contact with stud bumps 254, which act as the contacts with outer surface plating layer 250 of the second electrically conductive layer 244 of the second side 216 of the circuit substrate 212, at the chip engagement region 252. Using the flipchip method therefore results in the chip terminals 236 facing the circuit substrate 212. The IC chip 234 may then be adhered in place using an adhesive 256.

Whilst the flipchip embodiment of the smart card 210 has a lower profile than the wirebonded equivalent 110, there are other drawbacks. The primary weakness is that the PET circuit substrate 212 is far less robust than the FR-4 circuit substrate 112, and therefore it is possible that installation of the IC chip 234 can deform the circuit substrate 212, resulting in an outdentation on the first side 214, which can hamper the performance of the contact smart card 210. Furthermore, the requirement for a specifically-shaped chip engagement region 252 which is shaped to the size and form of the IC chip 234 means that a different circuit substrate must be prepared for each type of IC chip, even if the underlying circuitry is identical.

In both the wirebonded and flipchip methods of forming a contact smart card, there is an excessive use of precious and noble metals as defined above, along with other materials which exhibit resistance to corrosion and oxidation, such as nickel and copper, which are used to form and plate the electrically conductive layers; in the wirebonded embodiment 110, the wires 140 are formed from gold wire, whereas in the flipchip embodiment 210, both of the first and second sides 214, 216 are plated with expensive metals to limit oxidation and damage to the circuit.

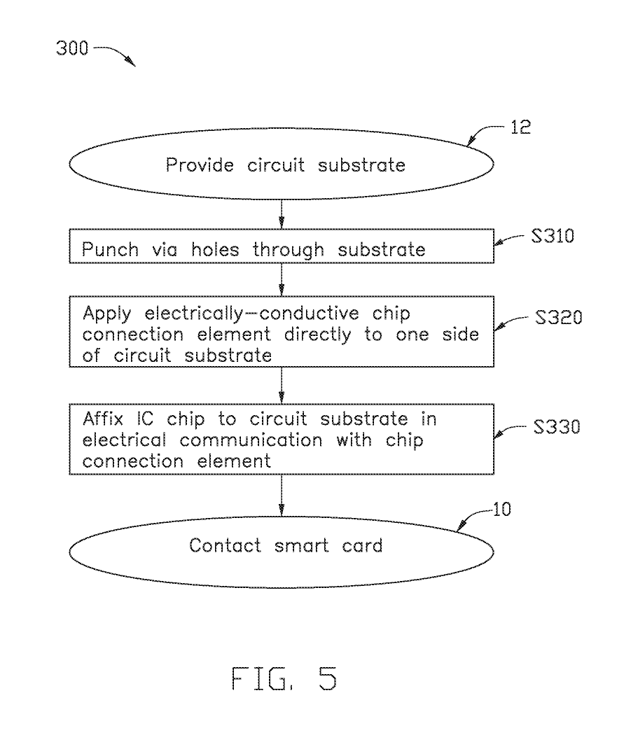

One embodiment of the present invention which overcomes the problems of both the wirebonding and flipchip methods is illustrated in FIGS. 3 and 4, and is indicated globally at 10, as a single-sided smart card module. Again, similar or identical reference numerals are used to refer to similar or identical components to those previously described, and further detailed description will therefore be omitted.

In the depicted embodiment, there is shown a circuit substrate 12 which is preferably formed from a glass epoxy laminate material so as to obviate the outdentation issues which are associated with the flipchip method, though any circuit substrate could feasibly be utilized if this issue were of lesser concern. The via holes 28 may also be mechanically punched, pierced, apertured or otherwise formed through a glass epoxy laminate material, rather than being laser ablated, which also limits collateral damage to the circuitry.

Onto the first side 14 of the circuit substrate 12 is provided an electrically conductive layer 18, here formed as a laminated copper layer. Whilst the electrically conductive layer is here shown as being bare copper, it is possible to provide a surface finish of, for example, gold and/or nickel, as in the previous prior art embodiments so as to protect the copper against corrosion and oxidation. The electrically conductive layer 18 defines a card-reader contact element 26.

The second side 16 of the circuit substrate 12 includes no laminated electrically conductive layer. Instead, a plurality of chip connection elements 58 is provided so as to be directly affixed to the second side 16 of the circuit substrate 12.

Whilst in the described embodiment there is no laminated electrically conductive layer at all disposed on the second side 16 of the circuit substrate, it is possible to reduce the level of lamination, rather than removing it entirely. For instance, it may be most preferable that there is no laminated electrically conductive layer in the vicinity of the chip-engagement region. It may therefore be feasible in some arrangements to have a partial covering of a laminated electrically conductive layer on other parts of the substrate neighboring or adjacent to chip-engagement region, if required, whilst keeping the chip-engagement region free or substantially free of lamination.

These chip connection elements 58 are formed from an electrically conductive material, such as nickel, and for example are soldered or otherwise mounted onto the surface of the circuit substrate 12. Optionally, the chip connection elements may be specifically electroplated onto the circuit substrate 12 as opposed to being soldered. In a preferred embodiment the chip connection elements 58 are formed by printing a conductive ink on the substrate 12. Although a silver based conductive ink is considered the most appropriate, other conductive inks may be suitable, depending on the specific requirements. Screen printing is one preferred printing method.

Each chip connection element 58 extends into, and may fill, the via hole 28 with which it is associated, thereby forming an electrical connection with the rear surface 30 of the electrically conductive layer 18. The chip connection elements 58 as a whole then can form a chip engagement region 52.

The IC chip 34, having chip terminals 36 which may conveniently be connected to stud bumps 54, can then be brought into electrical communication with the card-reader contact element 26 by installing the IC chip 34 at the chip engagement region 52 using an adhesive 56; the chip connection elements 58 provide an electrically conductive pathway through the via holes 28.

The fully assembled contact smart card 10 therefore combines the robustness of the flipchip method of assembly with the more flexible wirebonding technique, whilst also reducing the amount of precious metal required for the electrically conductive components than in either of the other cases. The chip-connection elements 58 could feasibly be formed from any appropriate electrically conductive layer, such as copper, nickel, gold, silver, carbon, graphite, graphene or an alloy, for instance.

The assembly of the smart card is illustrated in FIG. 5, indicated generally as 300. The circuit substrate 12 is provided. Via holes are punched in the substrate in step S310. The electrically conductive layer 18 is laminated, bonded, plated or formed onto its first side 14 after the via holes have been punched in the substrate, to close one end of the via holes and to form the card reader contact element.

Whilst the via holes are described as being mechanically punched, they could also be formed by other methods, such as piercing or aperturing, for example.

The chip engagement region 52 is then formed by applying at step S320 the electrically conductive chip connection element or elements 58 to the second side 16 of the circuit substrate 12, to which can be affixed at step S330 the IC chip 34, such that it is in electrical communication with the electrically conductive layer 18. This results in a contact smart card 10 in accordance with the present invention.

It will be appreciated that although the smart card of the invention has been described as having a plurality of via holes and chip connection elements, it is possible to envisage a smart card module having only a single said via hole or chip connection element, either in isolation, or in combination with other methods of attaching an IC chip to the module.

Furthermore, although the aim of the invention is to utilize flipchip-type methodology in combination with the more mature FR-4 type of circuit substrate, it will be appreciated that there is no specific requirement for a particular circuit substrate, and it is feasible, for instance, that it may be possible to apply chip connection elements directly to PET substrates.

It is therefore possible to provide a contact smart card which has a single-sided circuit substrate, the first, electrically conductive side of the substrate defining the card-reader contact element, with a plurality of chip connection elements being directly affixed to the opposite, second side of the circuit substrate. The chip connection elements provide an electrical connection from the first side to the second side, with the IC chip of the smart card being positioned on the second side.

This advantageously provides for a robust, slimline smart card with improved electrical connection, whilst also reducing the amount of precious metal used in its construction when compared with other methods of smart card construction. The chance of an open circuit when utilizing electrically conductive layers on opposing sides communicating using one or more via holes is also eliminated or reduced.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention herein described and defined.

1. A contact smart card comprising:
a smart card contact pad; and
an IC chip;
wherein the smart card contact pad comprises:
a circuit substrate including a plurality of via holes there through;
a card-reader contact element on a first side of the circuit substrate; and
a plurality of chip connection elements on a second side of the circuit substrate which is opposite the first side, each chip connection element being associated with a via hole through the circuit substrate;
the card-reader contact element having an electrically conductive surface;
the plurality of chip connection elements defining a chip engagement region on the second side of the circuit substrate; and
the IC chip being mounted on the chip engagement region and electrically connected to the card-reader contact element through the via holes.

2. The contact smart card of claim 1, further comprising an adhesive to adhere the IC chip to the chip engagement region.

3. The contact smart card of claim 1, wherein the circuit substrate is formed from an FR-4 grade epoxy glass laminate material.

4. The contact smart card of claim 1, wherein each of the plurality of chip connection elements fills its respective via hole with which it is associated.

5. The contact smart card of claim 1, wherein the first side of the circuit substrate includes an electrically conductive laminate layer, and the second side of the circuit substrate is devoid of an electrically conductive laminated layer.

6. The contact smart card of claim 5, wherein the electrically conductive laminate layer forms the card-reader contact element.

7. The contact smart card of claim 5, wherein the electrically conductive laminate layer is formed from copper.

8. The contact smart card of claim 1, wherein the contact smart card is a single-sided contact smart card module.

9. A method of forming a contact smart card without wire bonding, the method comprising the steps of:
a] providing a circuit substrate having a first side including an electrically conductive laminate layer thereon and a second side which is not laminated with an electrically conductive layer;
b] creating a via hole through the circuit substrate between the first and second sides;
c] applying an electrically conductive chip connection element directly to the second side of the circuit substrate at or adjacent to the via hole, such that the electrically conductive chip connection element is in electrical contact with the electrically conductive laminate layer through the via hole; and
d] affixing an IC chip to the second side of the circuit substrate, such that the IC chip is in electrical communication with the electrically conductive laminate layer via the electrically conductive chip connection element.

10. The method of claim 9, wherein a plurality of said via holes and electrically conductive chip connection elements are provided, the plurality of electrically conductive chip connection elements forming a chip engagement region capable of engaging with the IC chip.

11. The method of claim 9, wherein during step b], the via hole is formed as a mechanically punched hole in the circuit substrate.

12. The method as claimed in claim 9, wherein during step d], the IC chip is affixed to the second side of the circuit substrate using an adhesive.

13. The method of claim 9, wherein the circuit substrate is formed from an FR-4 grade epoxy glass laminate material.

14. A contact smart card comprising:
a smart card contact pad; and
an IC chip;
wherein the smart card contact pad comprises:
a circuit substrate including a plurality of via holes there through;
a card-reader contact element on a first side of the circuit substrate; and
a plurality of chip connection elements formed from an electrically conductive material and positioned on a second side of the circuit substrate which is opposite the first side, each chip connection element being associated with and extending into a via hole through the circuit substrate;
the card-reader contact element being formed from an electrically conductive material having an electrically conductive surface, wherein the card-reader contact element is formed from a different electrically conductive material to the plurality of chip connection elements;
the plurality of chip connection elements defining a chip engagement region on the second side of the circuit substrate; and
the IC chip being adhesively mounted on the chip engagement region and electrically connected to the card-reader contact element through the via holes.

15. The contact smart card of claim 14, wherein the circuit substrate is formed from an FR-4 grade epoxy glass laminate material.

16. The contact smart card of claim 14, wherein each of the plurality of chip connection elements fills its respective via hole with which it is associated.

17. The contact smart card of claim 14, wherein the contact smart card is a single-sided contact smart card module.

18. The contact smart card of claim 17, wherein the electrically conductive laminate layer forms the card-reader contact element.

19. The contact smart card of claim 17, wherein the electrically conductive laminate layer is formed from copper.
